(19) United States
(12) Patent Application Publication
(10) Pub. No.: US 2002/0084553 A1
(43) Pub. Date: Jul. 4, 2002

(54) Process for molding hydrophobic polymers to produce surfaces with stable water- and oil-repellent properties

(75) Inventors: Edwin Nun, Billerbeck (DE); Markus Oles, Hattingen (DE); Bernhard Schleich, Recklinghausen (DE); Andreas Gombert, Freiburg (DE); Klaus Rose, Kitzingen (DE); Gerhard Schottner, Heilsbronn (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS GESELLSCHAFT FUER TECHN. UND INNOV. MBH, Marl (DE)

(21) Appl. No.: 10/013,488

(22) Filed: Dec. 13, 2001

(30) Foreign Application Priority Data
Dec. 13, 2000 (DE) 100 62 203.8

(51) Int. Cl. B29C 59/02; B29C 59/04

(52) U.S. Cl. 264/284; 264/293; 264/338; 425/403; 425/385

(57) ABSTRACT

A process for embossing hydrophobic polymers with metallic embossing dies or embossing rolls, where the embossing dies or embossing rolls are hydrophobicized prior to the first embossing procedure. An embossing die or embossing roll for embossing hydrophobic polymers is also provided.

### BACKGROUND OF THE INVENTION

1. Field of the Invention

The present invention relates to a process for molding hydrophobic polymers using a embossing die or embossing roll that has been hydrophobicized. The present invention also relates to such a hydrophobicized embossing die or embossing roll.

2. Description of the Background

Hydrophobic and oleophobic surfaces are often required for industrial processes and for objects in everyday use. This requirement may be based on water repellency, e.g. for protective coverings made from plastics or for viewing windows. However, there may also be a requirement for effective prevention of adhesion of dirt particles, food or drink, microorganisms, paints, inks, resins or plastics, for example, on appropriate surfaces.

It is known that materials which are intrinsically hydrophobic and oleophobic, for example perfluorinated polymers, can be used to produce hydrophobicized and oleophobicized surfaces. There is a further development of these surfaces in which they have a structure in the μm to nm region. The resultant dynamic contact angle with water can be more than 150°. Droplet formation becomes markedly more pronounced, and, unlike on smooth surfaces, droplets readily run off even on surfaces with little inclination. This surface structure needs mechanical strength and must retain its hydrophobic and oleophobic properties over the course of time.

The literature provides an enormous number of proposals for producing surfaces of this type with the aid of silanes and fluorine compounds, and/or physical methods.

U.S. Pat. No. 5,599,489 describes a process in which a surface can be rendered particularly water-repellent by bombardment with particles, e.g. appropriately sized particles made from polyfluoroethylene, followed by perfluorination.

H. Saito et al. describe another process in Surface Coating International 4, 1997, pp. 168 et seq. Here, particles made from fluoro polymers are applied to metal surfaces, and the resultant surfaces were found to have markedly reduced wettability with respect to water and considerably reduced tendency toward icing.

U.S. Pat. No. 3,354,022 and WO 99/04123 describe other processes for lowering the wettability of objects by way of topological alterations to the surface. Here, artificial elevations and, respectively, depressions of height from about 5 to 1000 μm and with separation of from about 5 to 500 μm are applied to hydrophobic materials or to materials hydrophobicized after the structuring process. Surfaces of this type give rapid droplet formation, and as the droplets run off they pick up dirt particles and thus clean the surface.

A simple procedure for combining the surface properties of a low-energy surface with the physical properties of a conventional sheet is to laminate fluoro polymers on sheets made from polymethyl methacrylate (PMMA) or polycarbonate (JP 09 316 830). The outer film provides the surface properties desired, but impairs transmission. A considerable disadvantage of the method is that only flat objects are accessible to the process, and that only very coarse textures can be reproduced on the surface using films of this type.

Thinner polymer films can be produced if the organic fluorine-containing polymer films are applied by coating of the substrates from appropriate solutions. Use is frequently made of silanes here as adhesion promoters between substrate and coating. For example, polymeric substrates may first be pretreated with 3-aminopropyltriethoxysilane and then have a solution applied, e.g. one made from fluoropolymers, such as vinylidene fluoride copolymer (JP 08 277 379) or poly(perfluoro butylene vinyl ether) (JP 04 326 965). Depending on the procedure and on other constituents of the solution, this gives an extremely hard, scratch-resistant, firmly adhering and dirt-repellent coating. However, this procedure is complicated, since a number of components have to be applied one on top of the other, in a number of steps. The drying of polymer films causes wetting problems due to boundary effects in the case of textured surfaces, possible results being lack of coating of elevations and filling-in of valleys.

Other processes likewise use lacquer-like coating systems which are subsequently modified with fluoroalkyltrialkoxysilanes, in order to lower surface energy. A conventional procedure for achieving firm bonding of these fluoro-organic silanes is to begin by covering the substrate surface with metal oxides (JP 01 110 588 and JP 07 238 229). Aluminum oxide, zirconium oxide or silicon dioxide may be used here. This type of covering may also be achieved by admixing tetramethoxysilane with an acrylic urethane lacquer, which is cured by treatment with UV (EP 7890). Post-treatment, for example with perfluorooctylethylenetrimethoxysilanes, leads to condensation, forming covalent bonds between metal oxide and alkoxysilane unit. This method can generate scratch-resistant, dirt-repellent surfaces whose contact angle with respect to water is from 100 to 110°. Fine silicate particles may also be functionalized in advance with perfluorooctylenetrichlorosilanes and then be suspended in a UV-curable lacquer (JP 09 220 518). The curing of this matrix leads to coatings which give PMMA more pronounced water-repellent properties. A simpler method is the direct use of mixtures made from perfluorohexylethylenetrimethoxysilane and its hydrolysis products and acrylic monomers in a lacquer. Coating and UV curing leads to polymer films which adhere well to the substrate and have antifouling properties (JP 10 104 403).

A general disadvantage with the use of lacquers is the effect on transmission of light, by way of reflections at a number of boundaries with optical density differences. If use is also made of metal oxide particles, additional scattering effects tend to arise at the particles. The thickness of the lacquer layer also impedes coating for finely textured surfaces. Other defects of layers of this type are lack of elasticity and impact strength.

All of these procedures are inconvenient and require additional operations. A more elegant method is the use of fluorine-containing polymers or copolymers, which “by their nature” have certain hydrophobic and oleophobic properties. The hydrophobic and oleophobic properties of a surface may be altered by increasing the concentration of fluorine-containing polymer sequences at the boundaries, and in extreme cases only those of the upper atomic layers at the boundaries. Very thin layers of fluoro-organic polymer sequences are sufficient to give an adequate hydrophobic effect.

The use of low-pressure plasma for producing thin coatings are known (see “Thin Solid Films” (1997), 303 (1,2), 222-225). One possible process is the plasma polymerization of perfluorocycloalkane, leading to thin coverings of perfluoroalkanes on substrates (EP 0 590 007). Coatings of this type may also be achieved using plasma polymerization of vinylmethylsilanes or of vinyltrimethoxysilanes. A polymer formed here has lateral silanes or siloxane branches which may be used for coating various substrates. These coatings have unevenness dimensions of from 100 to 200 nm and have contact angles of almost 140° with respect to water (DE 195 431 33). However, when compared with solution-chemistry processes, the use of low-pressure plasma polymerization has hitherto been limited by the high associated costs for apparatus and time. Plasmas, and other physical processes, have also long been used to prepare polyolefins for painting, i.e. to activate the polyolefins and thus generate sites for the bonding of the coating to the substrate. There are also other physical processes which have been used for this purpose and have proven successful for plastics. JP 04 326 965, for example, describes the irradiation of a PC sheet with UV light prior to treatment with 3-aminopropyltrimethoxysilane.

Other processes produce structured oleophobic and hydrophobic surfaces via admixture of fluorine-containing polymer particles with polymer melts. These polymer blends are used for coating substrates. To avoid loss of surface roughness, use has to be made of binders and, where appropriate, coupling components (EP 0 825 241 or DE 197 159 06).

Embossing processes have been carried out using fluorine-containing polymers in order to obtain, in a simple manner, the desired combination of surface structure and surface chemistry, i.e. hydrophobic properties, examples of these processes are described in U.S. 3,354,022 and WO 96/04123.

There remains a continuing need for improved embossing processes and materials useful for such processes which overcome the disadvantages described above.

### SUMMARY OF THE INVENTION

The inventors' studies in relation to structured, fluorine-containing surfaces led to the finding that the surface of embossed fluorine-containing polymers has a lower level of hydrophobic properties than that possessed by polymers which have been embossed and subsequently hydrophobicized.

It was therefore an object of the present invention to develop a process for embossing hydrophobic polymers, giving the embossed surface better hydrophobic properties as compared to the non-embossed surface.

Surprisingly, it has been found that substrates can be embossed with substantial retention of hydrophobic properties, by using hydrophobic embossing materials.

Accordingly, the present invention provides a process for embossing at least one hydrophobic polymer with a metallic embossing die or embossing roll, which comprises hydrophobicizing the embossing die or embossing roll prior to the first embossing procedure.

The present invention provides a process for embossing at least one hydrophobic polymer with a metallic embossing die or embossing roll, which comprises

hydrophobicizing the embossing die or embossing roll and then

embossing the hydrophobic polymer.

The present invention also provides a hydrophobicized metallic embossing die or embossing roll suitable for embossing hydrophobic polymers.

The present invention also provides a process for rendering embossing dies or embossing rolls hydrophobic, comprising hydrophobicizing an embossing die or embossing roll, wherein the embossing die or embossing roll is suitable for embossing hydrophobic polymers.

A more complete appreciation of the invention and many of the attendant advantages thereof will be readily obtained as the same becomes better understood by reference to the following figures and detailed description.

### BRIEF DESCRIPTION OF THE FIGURES

FIG. 1: the results of an ESCA study of unembossed layers as described in the Example below.

FIG. 2: the results of an ESCA study of embossed layers as described in the Example below.

FIG. 3: the results of an ESCA study of embossed layers according to the process of the present invention as described in the Example below.

### DETAILED DESCRIPTION OF THE INVENTION

The wettability of surfaces can be described by measuring their surface energy. One way of gaining access to this variable, which is given in mN/m (millinewton per meter), is to measure the contact angle of various liquids on the smooth material (D. K. Owens, R. C. Wendt, J. Appl. Polym. Sci. 13, 1741 (1969), incorporated herein by reference). The surface energy determined by Owens et al. for smooth polytetrafluoroethylene surfaces is 19.1 mN/m, the contact angle with water being 110°. The contact angle of hydrophobic materials with water is generally above 90°.

It is advisable to determine the contact angle and, respectively, the surface energy on smooth surfaces since this gives better comparability. The hydrophobic properties of a material are determined by the chemical composition of the uppermost molecular layer of the surface. Coating processes are therefore one way of achieving a higher contact angle or a lower surface energy for a material.

Surfaces produced according to the present invention have higher contact angles than the corresponding smooth materials. The contact angle determined macroscopically is therefore a surface property which reflects not only the properties of the material but also the surface structure.

The present invention therefore provides metallic embossing dies for embossing hydrophobic polymers, in which embossing dies are hydrophobicized prior to the first embossing procedure.

The invention also provides a process for embossing hydrophobic polymers with metallic embossing dies, where the embossing dies are hydrophobicized prior to the first embossing procedure.

It should be expressly pointed out that the present process involves no transfer of the hydrophobic layer from the embossing die onto the substrate, and therefore—at least in theory—there is no need to hydrophobicize the embossing die more than once. Since it is impossible to avoid pure mechanical wear of the hydrophobic layer on the embossing die, the hydrophobicization should be repeated at regular intervals, e.g. after every 30th embossing procedure.

The embossing of the hydrophobic polymers serves to provide the polymer surface with structures of height from 50 nm to 1000 μm, preferably from 50 nm to 10 μm, and with a separation of from 50 nm to 500 μm, preferably from 50 nm to 10 μm.

The embossment may also be applied to hydrophobic polymers which are in the form of a layer on another polymer (matrix). Photochemically or thermally curable lacquers, e.g. arylate siloxanes (including those modified with up to 10 mol % of fluoroalkylsilane) or acrylates, which may also comprise ORMOCERe® materials or other additives, have proven particularly successful for layers of this type.

Use may therefore be made of the following acrylate siloxane modified with from 2 to 3 mol % of fluoroalkylsilane.

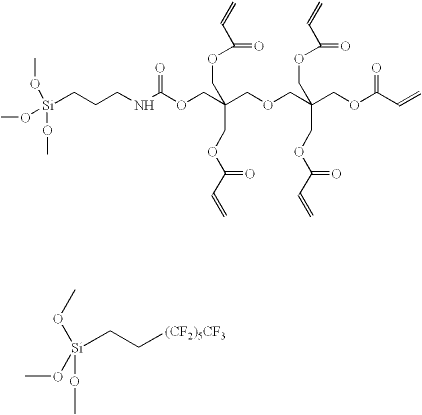

These lacquers are preferably applied in thicknesses of from 5 to 250 μm to a polymeric matrix, e.g. polymethyl methacrylate, PVC, polycarbonate, polyester, or other transparent polymers, and embossed with a metallic embossing die.

Examples of ways of curing the lacquer are by UV irradiation by way of the matrix, or thermally, by heating. Examples of photoinitiators which may be used are Lucrin or Irgacure 500, in each case at 3% by weight.

It is also possible to add crosslinkers, e.g. pentaerythritol triacrylate, pentaerythritol tetruacrylate, or trimethylolpropane triacrylate. In order to obtain embossed materials which are more abrasion-resistant, the use of SiO₂ particles (from 10 to 50 nm) or of SiO₂ sols is also recommended. Once the lacquer has cured, the embossing die is moved away, and the result is a structured surface (positive relative to the embossing die).

The metallic embossing dies known as shims preferably comprise nickel, or even have their embossing side composed entirely of nickel. Embossing dies are also understood to include structured rolls. They may have almost any desired metallurgical characteristics, but nickel is the preferred material.

Organosilanes for example

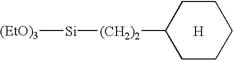

or preferably Fluor-organosilanes or Fluor-organosiloxanes, e g. Dynasilan F (Degussa-Hüls AG) or even condensates from a Sol-Gel-Process, although those condensates lead to thicker hydrophobic films may be used to hydrophobicize the embossing dies or rolls. Especially preferred is the use of partly condensated fluoroalkylsilanes, e.g. Dynasilan F 8810, fluoroalkylsilanes in general, e.g. C₃F₇—O—(CH₂)₃—SiCl₂(CH₃), perfluoroalkyltriethoxy silanes, e.g. F(CF2)n—CH₂CH₂—Si—(OC₂H₅)₃ with n=6, 8 or 10 or mixtures thereof, condensates obtained by sol-gel-processes or fluoroalkyl-siloxanes, e.g. 1H, 1H, 2H, 2H-Perfluorooctylmethylsiloxane.

### EXAMPLES

Having generally described this invention, a further understanding can be obtained by reference to certain specific examples which are provided herein for purposes of illustration only and are not intended to be limiting unless otherwise specified.

### Example

Fluoroalkylsilane-modified acrylate siloxane, both unstructured and structured with a nickel embossing die with a period of 1 μm, is in each case cured with UV light.

The resultant angles of contact with respect to water were about 90° (unstructured) and from 120 to 130° (structured).

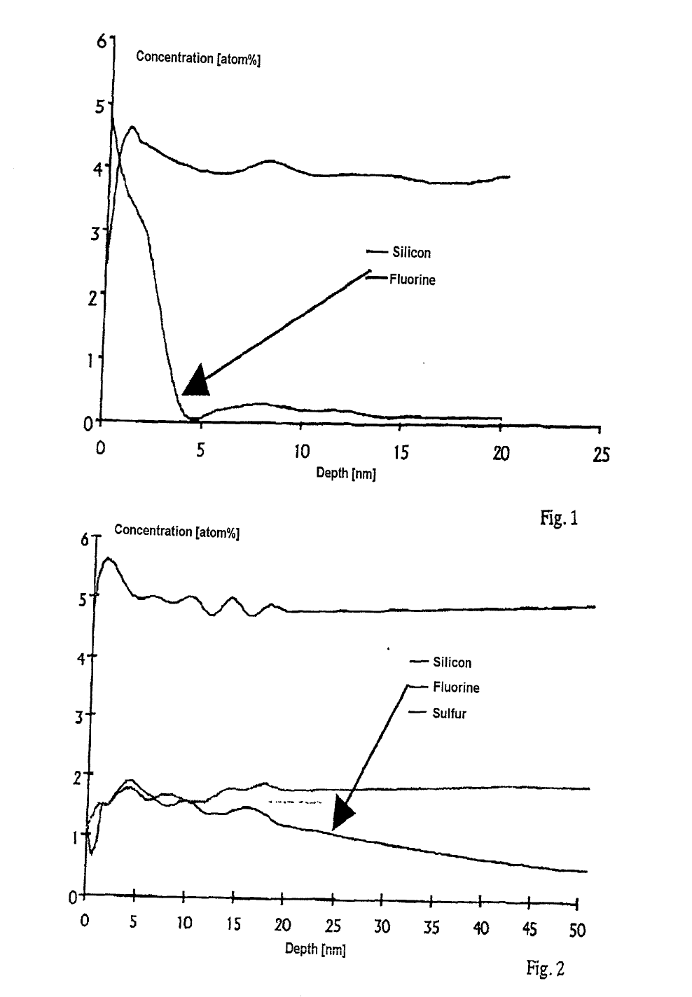

ESCA studies on the unembossed (FIG. 1) and embossed layers (FIG. 2) showed that a markedly smaller proportion of the fluorine groups is to be found in the surface of the layer after the embossing procedure, and this explains the small contact angle of the embossed (structured) material.

The nickel embossing die was dipped in a 1% alcoholic solution of a fluoroalkylsilane (3,3,4,4,5,5,6,6,7,7,8,8,8-tridecafluorooctyltriethoxysilane), and then dried at 80° C. for 30 minutes. Another embossing process with fluoroalkylsilane-modified acrylic siloxane gave surfaces with a contact angle of about 150° with respect to water.

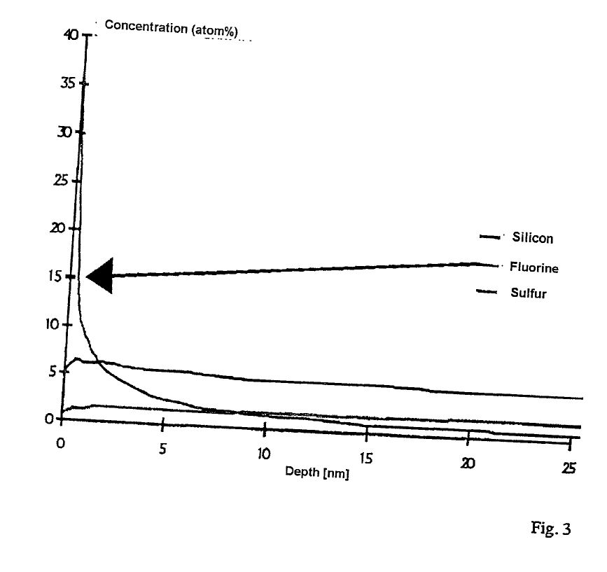

A contact angle of about 150° with water was not obtained without treatment with an alcoholic fluoroalkylsilane hydrolyzate solution, and in this case the water droplets also exhibited spontaneous run-off from the surface. FIG. 3 shows that the concentration of fluorine atoms is not impaired by the embossing process of the invention, and the hydrophobic properties of the embossed structure are therefore better than those obtained from the non-inventive embossing procedure.

Obviously, numerous modifications and variations of the present invention are possible in light of the above teachings. It is therefore to be understood that within the scope of the appended claims, the invention may be practiced otherwise than as specifically described herein.

This application is based on German Patent Application Serial No. 10062203.8, filed on Dec. 13, 2000, and incorporated herein by reference in its entirety.

1. A process for embossing at least one hydrophobic polymer with a metallic embossing die or embossing roll, which comprises hydrophobicizing the embossing die or embossing roll prior to the first embossing procedure.

2. The process of claim 1, wherein the hydrophobic polymer is selected from the group consisting of fluorine-containing polymers, surface coatings, and resins.

3. The process of claim 1, wherein the hydrophobic polymer comprises surface coatings, resins, or fluorine-containing copolymers.

4. The process of claim 1, wherein the hydrophobic polymer comprises surface coatings, resins, or fluorine-containing polymer blends.

5. The process of claim 1, wherein the hydrophobic polymer is in the form of a layer on another polymer matrix.

6. The process of claim 5, wherein the polymer matrix is composed of at least one polymer selected from the group consisting of polymethyl methacrylate, PVC, polycarbonate, and polyester.

7. The process of claim 1, wherein the embossing die or embossing roll comprises nickel.

8. The process of claim 1, wherein the embossing die or embossing roll is hydrophobicized with at least one fluoroorganosilane.

9. The process of claim 8, wherein the fluoroorganosilane is 3,3,4,4,5,5,6,6,7,7,8,8,8-tridecafluorooctyltriethoxysilane.

10. The process of claim 1, wherein the embossing die or embossing roll is hydrophobicized with at least one organosilane.

11. The process of claim 10, wherein the organosilane is represented by the formula

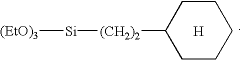

12. A process for embossing at least one hydrophobic polymer with a metallic embossing die or embossing roll, which comprises
hydrophobicizing the embossing die or embossing roll and then
embossing the hydrophobic polymer.

13. The process of claim 12, wherein the hydrophobic polymer is selected from the group consisting of fluorine-containing polymers, surface coatings, and resins.

14. The process of claim 12, wherein the hydrophobic polymer comprises surface coatings, resins, or fluorine-containing copolymers.

15. The process of claim 12, wherein the hydrophobic polymer comprises surface coatings, resins, or fluorine-containing polymer blends.

16. The process of claim 12, wherein the hydrophobic polymer is in the form of a layer on another polymer matrix.

17. The process of claim 14, wherein the polymer matrix is composed of at least one polymer selected from the group consisting of polymethyl methacrylate, PVC, polycarbonate, and polyester.

18. The process of claim 12, wherein the embossing die or embossing roll comprises nickel.

19. The process of claim 12, wherein the embossing die or embossing roll is hydrophobicized with at least one fluoroorganosilane.

20. The process of claim 19, wherein the fluoroorganosilane is 3,3,4,4,5,5,6,6,7,7,8,8,8-tridecafluorooctyltriethoxysilane.

21. The process of claim 12, wherein the embossing die or embossing roll is hydrophobicized with at least one organosilane.

22. The process of claim 21, wherein the organosilane is represented by the formula

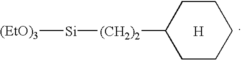

23. A hydrophobicized metallic embossing die or embossing roll suitable for embossing hydrophobic polymers.

24. The metallic embossing die or embossing roll of claim 23, which is hydrophobicized with a fluoroorganosilane.

25. The hydrophobicized metallic embossing die or embossing roll of claim 24, wherein the fluoroorganosilane is 3,3,4,4,5,5,6,6,7,7,8,8,8-tridecafluorooctyltriethoxysilane.

26. The hydrophobicized metallic embossing die or embossing roll of claim 24, which is hydrophobicized with at least one organosilane.

27. The hydrophobicized metallic embossing die of embossing roll of claim 26, wherein the organosilane is represented by the formula

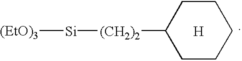

28. The hydrophobicized metallic embossing die or embossing roll of claim 24, which comprises nickel.

29. A process for rendering embossing dies or embossing rolls hydrophobic, comprising hydrophobicizing an embossing die or embossing roll, wherein the embossing die or embossing roll is suitable for embossing hydrophobic polymers.

30. The process of claim 29, which is hydrophobicized with a fluoroorganosilane.

31. The process of claim 30, wherein the fluoroorganosilane is 3,3,4,4,5,5,6,6,7,7,8,8,8-tridecafluorooctyltriethoxysilane.

32. The process of claim 29, wherein the embossing die or embossing roll is hydrophobicized with at least one organosilane.

33. The process of claim 32, wherein the organosilane is represented by the formula

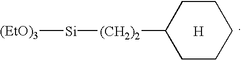

34. The hydrophobicized metallic embossing die or embossing roll of claim 23, which comprises nickel.

35. In process for embossing hydrophobic polymers with a metallic embossing die or embossing roll, the improvement comprising hydrophobicizing the embossing die or embossing roll prior to embossing.

36. The process of claim 35, which is hydrophobicized with a fluoroorganosilane.

37. The process of claim 36, wherein the fluoroorganosilane is 3,3,4,4,5,5,6,6,7,7,8,8,8-tridecafluorooctyltriethoxysilane.

38. The process of claim 35, wherein the embossing die or embossing roll is hydrophobicized with at least one organosilane.

39. The process of claim 38, wherein the organosilane is represented by the formula

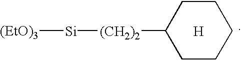

40. The process wherein the hydrophobicized metallic embossing die or embossing roll comprises nickel.
